(19) United States
(12) Patent Application Publication
(10) Pub. No.: US 2012/0019443 A1
(43) Pub. Date: Jan. 26, 2012

(54) TOUCH SYSTEM AND TOUCH SENSING METHOD

(75) Inventors: HSIN-CHIA CHEN, Hsinchu (TW); Horng-Goung Lai, Hsinchu (TW); Chih-Hung Lu, Hsinchu (TW)

(73) Assignee: PixArt Imaging Inc., HSINCHU (TW)

(21) Appl. No.: 13/037,581

(22) Filed: Mar. 1, 2011

(30) Foreign Application Priority Data
Jul. 21, 2010 (TW) 099123974

(51) Int. Cl. G06F 3/033

(52) U.S. Cl. 345/158

(57) ABSTRACT

A touch system comprises a transparent panel, a first image sensing module, a second image sensing module and a processing circuit. The first image sensing module is at least partially disposed on a first flat surface of the transparent for obtaining an image above the first flat surface. The second image sensing module is at least partially disposed under a second flat surface of the transparent for obtaining an image of the first flat surface through the second flat surface. When two pointers approach the first flat surface, the processing circuit calculates possible coordinates of the pointers according to the image obtained by the first image sensing module and calculates coordinates of the pointers according to the image obtained by the second image sensing module, so as to compare all of the coordinates to obtain actual coordinates of the pointers from the possible coordinates.

This application claims the priority benefit of Taiwan application serial no. 099123974, filed on Jul. 21, 2010, the entire contents of which are hereby incorporated by reference.

### FIELD OF THE INVENTION

The present invention relates to the touch technology and, more particularly, to a touch system and a touch sensing method thereof.

### BACKGROUND OF THE INVENTION

FIG. 1 shows a three dimensional view of a conventional touch system. Referring to FIG. 1, the touch system 100 is configured for obtaining a coordinate of a pointer 102. The touch system 100 comprises a panel 104, an image sensing apparatus 106, an image sensing apparatus 108 and a processing circuit 110. Furthermore, the touch system 100 also comprises a reflective element 112, a reflective element 114 and a reflective element 116. A quadrangular region marked by a mark number 118 is used as a sensing region of the touch system 100. The shape of the sensing region 118 is preferably a rectangle. The processing circuit 110 is electrically coupled to the image sensing apparatuses 106 and 108, so as to calculate the coordinate of the pointer 102 according to the pointer images sensed by the two image sensing apparatuses. The detailed sensing principle of the touch system 100 and the method for calculating the coordinate of the pointer may refer to the description and the teaching disclosed in Taiwan application Ser. No. 097126033. And this will not be described herein.

FIG. 2 is a schematic view for describing the touch system 100 performing a single-touch operation. In FIG. 2, the mark numbers same to those of FIG. 1 represent the same objects. As shown in FIG. 2, the image sensing apparatus 106 can sense the pointer 102 along a sensing route 202, and the image sensing apparatus 108 can sense the pointer 102 along a sensing route 204. As long as the processing circuit 110 calculates an intersection point of the sensing routes 202 and 204 the processing circuit 110 can obtain the coordinate of the pointer 102. However, when the touch system 100 performs a multi-touch operation, many problems may be occurred, which will be described by FIG. 3.

FIG. 3 is a schematic view for describing the touch system 100 performing the multi-touch operation, which takes two touch points as an example. In FIG. 3, the mark numbers same to those of FIG. 1 represent the same objects, and mark numbers 302 and 304 represent the pointers. As shown in FIG. 3, the image sensing apparatus 106 can sense the pointer 302 and the pointer 304 along a sense route 202 and a sense route 312 respectively, and the image sensing apparatus 108 can sense the pointer 302 and the pointer 304 along a sense route 204 and a sense route 314 respectively. However, since the processing circuit 110 obtains the locations of the pointers 302 and 304 by calculating the intersection points of the sensing routes, the processing circuit 110 will regard the locations marked by mark numbers 306 and 308 as the possible locations of the pointers 302 and 304 in this condition. The locations marked by mark numbers 306 and 308 are so called ghost points. Therefore, the processing circuit 110 will not accurately determine the actual coordinates of the pointers 302 and 304.

### SUMMARY OF THE INVENTION

The present invention relates to a touch system, which can accurately determine actual coordinates of pointers when performing a multi-touch operation.

The present invention also relates to a touch sensing method, which is adapted to the above touch system.

The present invention provides a touch system, which comprises a transparent panel, a first image sensing module, a second image sensing module and a processing circuit. The transparent panel has a first flat surface and a second flat surface opposite to the first flat surface. The first image sensing module is at least partially disposed on the first flat surface for obtaining an image above the first flat surface. The second image sensing module is at least partially disposed under the second flat surface for obtaining an image of the first flat surface through the second flat surface. When a first pointer and a second pointer approach the first flat surface, the processing circuit calculates possible coordinates of the pointers according to the image obtained by the first image sensing module and calculates coordinates of the pointers according to the image obtained by the second image sensing module, so as to compare all of the coordinates to obtain actual coordinates of the pointers from the possible coordinates.

The present invention also provides a touch sensing method adapted to a touch system. The touch system comprises a transparent panel, a first image sensing module and a second image sensing module. The transparent panel has a first flat surface and a second flat surface opposite to the first flat surface. The first image sensing module is at least partially disposed on the first flat surface for obtaining an image above the first flat surface. The second image sensing module is at least partially disposed under the second flat surface for obtaining an image of the first flat surface through the second flat surface. The method comprises the following steps: calculating possible coordinates of a first pointer and a second pointer according to the image obtained by the first image sensing module and calculating coordinates of the pointers according to the image obtained by the second image sensing module when the first pointer and the second pointer approach the first flat surface; and comparing all of the coordinates to obtain actual coordinates of the pointers from the possible coordinates.

The touch system of the present invention mainly comprises one transparent panel and two image sensing modules. Furthermore, one of the two image sensing modules is at least partially disposed on a first flat surface of the transparent panel, and the other image sensing module is at least partially disposed under a second flat surface of the transparent panel. Therefore, when two pointers approach the first flat surface, the image sensing module disposed on the first flat surface can be employed to obtain an image above the first flat surface, so as to calculate the possible coordinates of the pointers according to the image obtained by the image sensing module. At this moment, the image sensing module disposed under the second flat surface can also be employed to obtain an image of the first flat surface through the second flat surface, so as to calculate the coordinates of the pointers according to the image obtained by this image sensing module. After all of the coordinates have been obtained, all of the obtained coordinates can be compared with each other to obtain the actual coordinates of the pointers from the possible coordinates.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 shows a three dimensional view of a conventional touch system.

FIG. 2 is a schematic view for describing the touch system performing a single-touch operation.

FIG. 3 is a schematic view for describing the touch system performing the multi-touch operation.

FIG. 4 is a schematic view for describing the disposing relation of a transparent panel and image sensing apparatuses of the touch system.

FIG. 5 is a structure schematic view of an image sensing apparatus.

FIG. 6 is a schematic view for describing the disposing relation of a transparent panel and image sensing apparatuses of the touch system.

FIG. 7 is a schematic view of a liquid crystal display panel.

FIG. 8 is a flow chart of a touch sensing method in accordance with an exemplary embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

### First Exemplary Embodiment

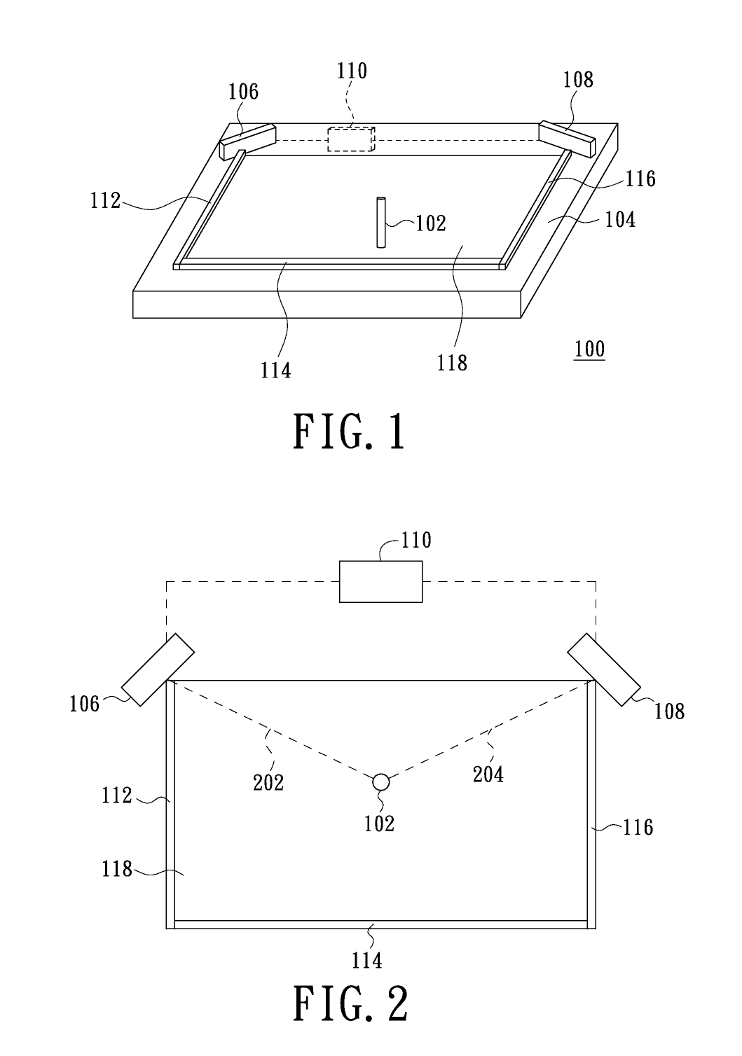

A touch system of this exemplary embodiment has a hardware structure similar to that of the touch system as shown in FIG. 1. Therefore, the following will employ the hardware structure as shown in FIG. 1 to describe the touch system of this exemplary embodiment.

Referring to FIG. 1, the touch system 100 of the present invention alters a part of the panel 104, corresponding to the sensing region 118, to be a transparent panel (not marked). And the transparent panel is not limited to have a thickness the same with those of the panel 104. The transparent panel has a first flat surface (not marked) and a second flat surface (not marked). The first flat surface is used as an actual surface corresponding to the sensing region 118, and the second flat surface is opposite to the first flat surface. The two flat surfaces are preferably parallel with each other.

In addition, the image sensing apparatuses 106 and 108 are disposed at two different corners of the first flat surface, and sensing ranges of the two image sensing apparatuses are at least partially overlapped. In the touch system 100, the two image sensing apparatuses 106 and 108 belong to a first image sensing module. As shown in FIG. 1, the first image sensing module is at least partially disposed on the first flat surface, so as to obtain an image above the first flat surface. Therefore, the first image sensing module is also called a side image sensing module. The touch system 100 further comprises a second image sensing module (not shown). The second image sensing module is at least partially disposed under the second flat surface of the transparent panel, so that the second image sensing module can obtain an image of the first flat surface through the second flat surface. Therefore, the second image sensing module is also called a back image sensing module. In the exemplary embodiment, the second image sensing module comprises an image sensing apparatus (not shown), and the image sensing apparatus is also electrically coupled to the processing circuit 110.

FIG. 4 is a schematic view for describing the disposing relation of the transparent panel and the image sensing apparatuses of the above touch system. As shown in FIG. 4, the image sensing apparatuses 106 and 108 of the first image sensing module are disposed on the first flat surface 402-1 of the transparent panel 402, and the image sensing apparatus 404 of the second image sensing module is disposed under the second flat surface 402-2 of the transparent panel 402. In addition, the image sensing apparatus 404 has a wide-angle lens (not shown), and a visual angle of the wide-angle lens covers the second flat surface 402-2 and the first flat surface 402-1 of the transparent panel 402.

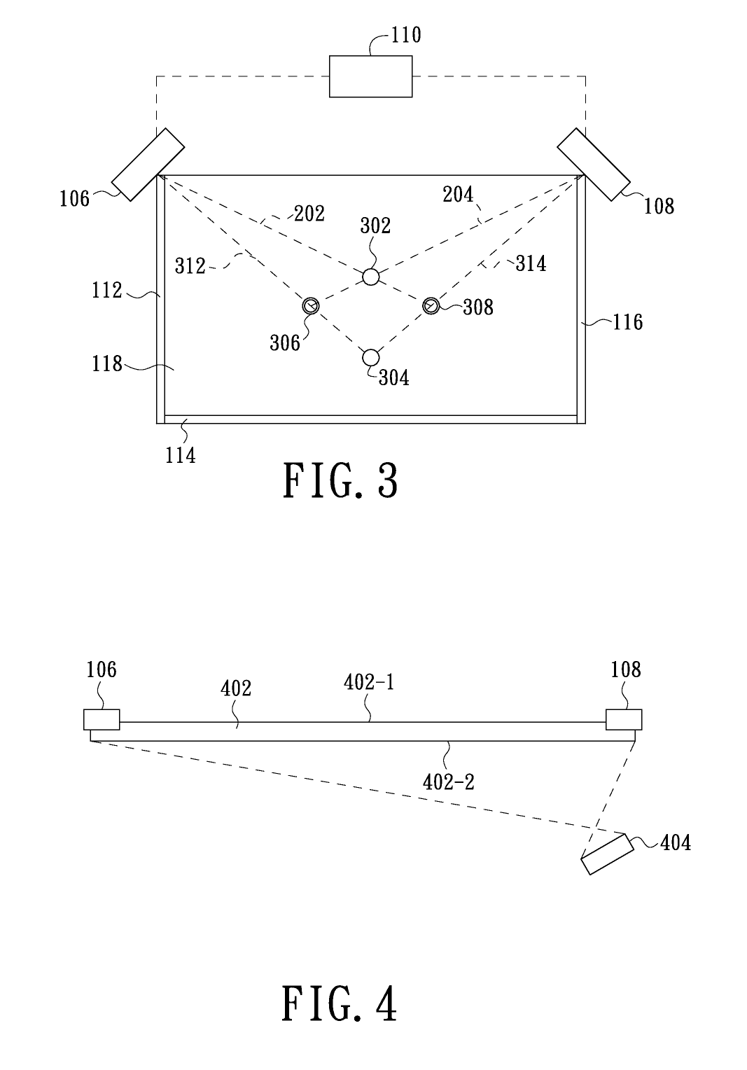

From the disposing relation described in the above, it can be seen that the processing circuit 110 of the touch system 100 can calculate the possible coordinates of two pointers according to the image obtained by the first image sensing module when the two pointers approach the first flat surface 402-1. The calculating result is still the same with that as shown in FIG. 3, and the calculating result indicates four possible coordinates. However, since the processing circuit 110 of the touch system 100 can also calculate the coordinates of the two pointers according to the image obtained by the second image sensing module and the second image sensing module senses only the actual locations of the two pointers without any ghost points, the processing circuit 110 can further compare all of the obtained coordinates (such as obtaining the intersection of all obtained coordinates by comparing), so as to obtain the actual coordinates of the two pointers from the four possible coordinates.

From the above description, it can be seen that the operation of obtaining the intersection of all obtained coordinates by comparing is to employ the sensing result of the second image sensing module to eliminate the ghost points in the sensing result of the first image sensing module. Therefore, the touch system 100 of the present invention can accurately determine the actual coordinates of the pointers.

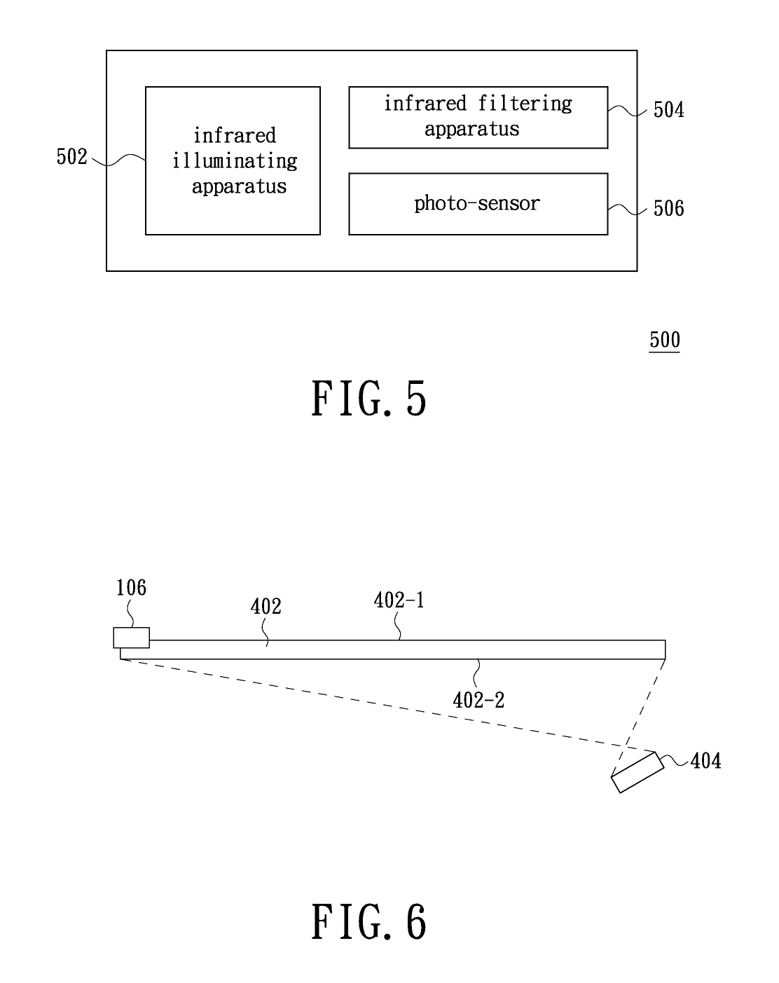

FIG. 5 is a structure schematic view of each of the image sensing apparatuses. Referring to FIG. 5, the image sensing apparatus 500 comprises an infrared (IR) illuminating apparatus 502, an infrared filtering apparatus 504 allowing only infrared light to pass through, and a photo-sensor 506. The photo-sensor 506 is used for obtaining an image through the infrared filtering apparatus 504 and is electrically coupled to the processing circuit 110 for transmitting the obtained image to the processing circuit 110. In addition, the infrared illuminating apparatus 502 can be an infrared LED, and the infrared filtering apparatus 504 can be an infrared-pass filter.

In addition, the exemplary embodiment employs the reflective element 112, the reflective element 114 and the reflective element 116 to reflect light to the first flat surface 402-1, so as to form a bright region with high illumination on the obtained image to highlighting the dark strips formed on the obtained image since the pointers shield the reflective light. However, it is understood for persons skilled in the art that each of the above reflective elements can be replaced by a light-emitting element as long as the light-emitting element emits light towards the first flat surface 402-1.

### Second Exemplary Embodiment

From the first exemplary embodiment, it is understood for persons skilled in the art that the image sensing apparatus of the second image sensing module does not need any infrared filtering apparatus if the transparent panel 402 is implemented by an infrared filtering apparatus.

### Third Exemplary Embodiment

The exemplary embodiment mainly describes the first image sensing module (i.e., the side image sensing module) can be implemented by an image sensing apparatus and a plane mirror. Thus, the first image sensing module does not need two image sensing apparatuses. This will employ FIG. 3 again to describe. Referring to FIG. 3, in the exemplary embodiment, the first image sensing module only comprises one of the two image sensing apparatuses 106 and 108, and the reflective element 114 is replaced by a plane mirror. The plane mirror is configured for generating an image above the first flat surface 402-1 of the transparent panel 402. It should be noted that the image sensing apparatus of the first image sensing module has a sensing range covering the first flat surface 402-1 of the transparent panel 402 and the plane mirror.

FIG. 6 is a schematic view for describing the disposing relation of the transparent panel and the image sensing apparatuses of the touch system. As shown in FIG. 6, the first image sensing module only comprises the image sensing apparatus 106, and the image sensing apparatus 106 is disposed on the first flat surface 402-1 of the transparent panel 402. The image sensing apparatus 404 of the second image sensing module is disposed under the second flat surface 402-2 of the transparent panel 402. In addition, the image sensing apparatus 404 has a wide-angle lens (not shown), and a visual angle of the wide-angle lens covers the second flat surface 402-2 and the first flat surface 402-1 of the transparent panel 402.

The detailed sensing principle and the method for calculating the coordinates of the pointers of the touch system may refer to the description and the prior art disclosed in Taiwan application Ser. No. 097126033. And this will not be described herein.

It should be noted that the reflective element 112 may be omitted if the first image sensing module only comprises the image sensing apparatus 106. On the contrary, the reflective element 116 may be omitted if the first image sensing module only comprises the image sensing apparatus 108. In addition, each of the image sensing apparatuses of the exemplary embodiment may have the structure as shown in FIG. 5. Certainly, if the transparent panel 402 is implemented by an infrared filtering apparatus, the image sensing apparatus of the second image sensing module does not need any infrared filtering apparatus.

### Fourth Exemplary Embodiment

The exemplary embodiment mainly describes the transparent panel 402 of the touch system 100 may be replaced by a display panel such as a liquid crystal display panel or an electrophoresis display panel. However, the image sensing apparatus of the second image sensing module of the touch system 100 must be disposed at a different location. The following will employ the liquid crystal display panel as an exemplary embodiment.

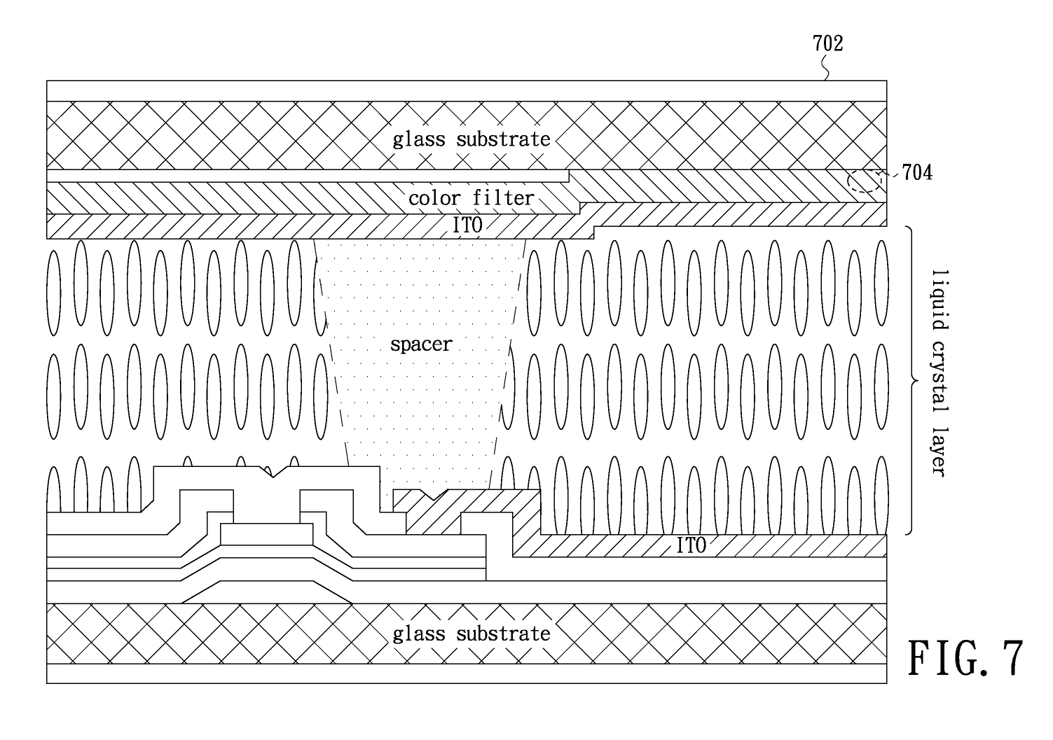

FIG. 7 is a schematic view of a liquid crystal display panel. The display surface 702 of the liquid crystal display panel is configured for displacing the first flat surface 402-1 of the transparent panel 402. The image sensing apparatus of the second image sensing module may be disposed between the color filter and the glass substrate near the color filter, and the disposed location must not be shielded by the black matrix (BM) such as the location marked by a hidden-line frame 704.

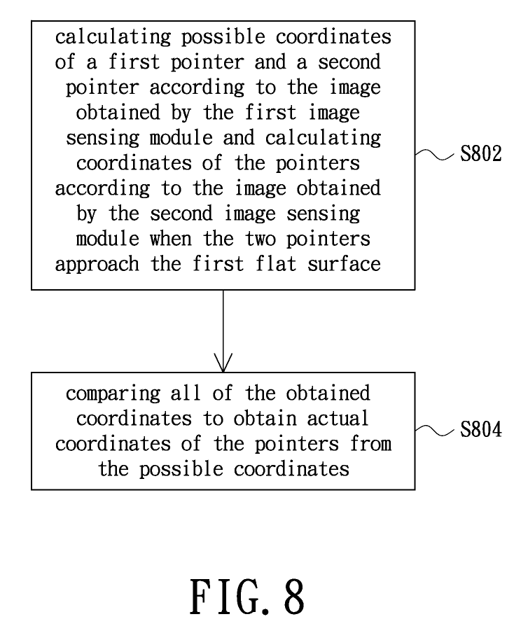

From the description of the above exemplary embodiments, it is understood for persons skilled in the art to conclude a touch sensing method as shown in FIG. 8. FIG. 8 is a flow chart of a touch sensing method in accordance with an exemplary embodiment of the present invention. The touch sensing method is adapted to a touch system. The touch system comprises a transparent panel, a first image sensing module and a second image sensing module. The transparent panel has a first flat surface and a second flat surface opposite to the first flat surface. The first image sensing module is at least partially disposed on the first flat surface, so as to obtain an image on the first flat surface. The second image sensing module is at least partially disposed under the second flat surface, so as to obtain an image of the first flat surface through the second flat surface. The method comprises the following steps: calculating the possible coordinates of a first pointer and a second pointer according to the image obtained by the first image sensing module and calculating the coordinates of the pointers according to the image obtained by the second image sensing module when the pointers approach the first flat surface (as shown in step S802); and comparing all of the coordinates to obtain the actual coordinates of the pointers from the possible coordinates (as shown in step S804).

In summary, the touch system of the present invention mainly comprises one transparent panel and two image sensing modules. Furthermore, one of the two image sensing modules is at least partially disposed on a first flat surface of the transparent panel, and the other image sensing module is at least partially disposed under a second flat surface of the transparent panel. Therefore, when two pointers approach the first flat surface, the image sensing module disposed on the first flat surface can be employed to obtain an image above the first flat surface, so as to calculate the possible coordinates of the pointers according to the image obtained by the image sensing module. At this moment, the image sensing module disposed under the second flat surface can also be employed to obtain an image of the first flat surface through the second flat surface, so as to calculate the coordinates of the pointers according to the image obtained by this image sensing module. After all of the coordinates have been obtained, all of the obtained coordinates can be compared with each other to obtain the actual coordinates of the pointers from the possible coordinates.

In addition, the touch system of the present invention can be used alone, or be used by cooperating with the display panel, even cooperating with the surface table.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A touch system, comprising:
a transparent panel, having a first flat surface and a second flat surface opposite to the first flat surface;
a first image sensing module, at least partially disposed on the first flat surface for obtaining an image above the first flat surface;
a second image sensing module, at least partially disposed under the second flat surface for obtaining an image of the first flat surface through the second flat surface; and
a processing circuit, configured for calculating possible coordinates of a first pointer and a second pointer according to the image obtained by the first image sensing module, calculating coordinates of the pointers according to the image obtained by the second image sensing module, and comparing all of the obtained coordinates to obtain actual coordinates of the pointers from the possible coordinates when the pointers approach the first flat surface.

2. The touch system according to claim 1, wherein the shape of the transparent panel is a quadrangle, the transparent panel has a first boundary, a second boundary, a third boundary and a fourth boundary connected in sequence, the first image sensing module comprises a first image sensing apparatus and a second image sensing apparatus, the first image sensing apparatus is disposed at a corner where the first boundary and the fourth boundary intersect with each other, the second image sensing apparatus is disposed at a corner where the first boundary and the second boundary intersect with each other, the sensing ranges of the first image sensing apparatus and the second image sensing apparatus are at least partially overlapped, and the second image sensing module comprises a third image sensing apparatus.

3. The touch system according to claim 2, wherein each of the image sensing apparatus comprises an infrared illuminating apparatus and an infrared filtering apparatus allowing only infrared light to pass through, the infrared illuminating apparatus comprises an infrared LED, and each of the image sensing apparatus obtains an image through a corresponding infrared filtering apparatus.

4. The touch system according to claim 2, wherein each of the image sensing apparatus comprises an infrared illuminating apparatus, the infrared illuminating apparatus comprises an infrared LED, each of the first image sensing apparatus and the second image sensing apparatus comprises an infrared filtering apparatus allowing only infrared light to pass through, and the transparent panel is also implemented by an infrared filtering apparatus.

5. The touch system according to claim 2, wherein the third image sensing apparatus comprises a wide-angle lens, and a visual angle of the wide-angle lens covers the second flat surface and the first flat surface.

6. The touch system according to claim 2, further comprising a first light-emitting element, a second light-emitting element and a third light-emitting element, wherein the first light-emitting element, the second light-emitting element and the third light-emitting element are disposed on the second boundary, the third boundary and the fourth boundary respectively, so as to emit light towards the first flat surface.

7. The touch system according to claim 2, further comprising a first reflective element, a second reflective element and a third reflective element, wherein the first reflective element, the second reflective element and the third reflective element are disposed on the second boundary, the third boundary and the fourth boundary respectively, so as to reflect light to the first flat surface.

8. The touch system according to claim 1, wherein the shape of the transparent panel is a quadrangle, the transparent panel has a first boundary, a second boundary, a third boundary and a fourth boundary connected in sequence, the first image sensing module comprises a first image sensing apparatus and a plane mirror, the plane mirror is disposed on the third boundary for generating a mirror image above the first flat surface, the first image sensing apparatus is disposed at a corner where the first boundary and the fourth boundary intersect with each other, a sensing range of the first image sensing apparatus covers the first flat surface and the plane mirror, and the second image sensing module comprises a second image sensing apparatus.

9. The touch system according to claim 8, wherein each of the image sensing apparatus comprises an infrared illuminating apparatus and an infrared filtering apparatus allowing only infrared light to pass through, the infrared illuminating apparatus comprises an infrared LED, and each of the image sensing apparatus obtains an image through a corresponding infrared filtering apparatus.

10. The touch system according to claim 8, wherein each of the image sensing apparatus comprises an infrared illuminating apparatus, the infrared illuminating apparatus comprises an infrared LED, the first image sensing apparatus further comprises an infrared filtering apparatus allowing only infrared light to pass through, and the transparent panel is also implemented by an infrared filtering apparatus.

11. The touch system according to claim 8, wherein the second image sensing apparatus comprises a wide-angle lens, and a visual angle of the wide-angle lens covers the second flat surface and the first flat surface.

12. The touch system according to claim 8, further comprising a light-emitting element, wherein the light-emitting element is disposed on the second boundary, so as to emit light towards the first flat surface.

13. The touch system according to claim 8, further comprising a reflective element, wherein the reflective element is disposed on the second boundary, so as to reflect light towards the first flat surface.

14. A touch sensing method adapted to a touch system, the touch system comprising a transparent panel, a first image sensing module and a second image sensing module, the transparent panel having a first flat surface and a second flat surface opposite to the first flat surface, the first image sensing module being at least partially disposed on the first flat surface for obtaining an image above the first flat surface, the second image sensing module being at least partially disposed under the second flat surface for obtaining an image of the first flat surface through the second flat surface, the method comprising:
calculating possible coordinates of a first pointer and a second pointer according to the image obtained by the first image sensing module, and calculating coordinates of the pointers according to the image obtained by the second image sensing module when the first pointer and the second pointer approach the first flat surface; and
comparing all of the coordinates to obtain actual coordinates of the pointers from the possible coordinates.

15. The touch sensing method according to claim 14, wherein the transparent panel is a quadrangle, the transparent panel has a first boundary, a second boundary, a third boundary and a fourth boundary connected in sequence, the first image sensing module comprises a first image sensing apparatus and a second image sensing apparatus, the first image sensing apparatus is disposed at a corner where the first boundary and the fourth boundary intersect with each other, the second image sensing apparatus is disposed at a corner where the first boundary and the second boundary intersect with each other, sensing ranges of the first image sensing apparatus and the second image sensing apparatus are at least partially overlapped, the second image sensing module comprises a third image sensing apparatus, and the step of obtaining the image is employing the image sensing apparatus to obtain the image.

16. The touch sensing method according to claim 14, wherein the shape of the transparent panel is a quadrangle, the transparent panel has a first boundary, a second boundary, a third boundary and a fourth boundary connected in sequence, the first image sensing module comprises a first image sensing apparatus and a plane mirror, the plane mirror is disposed on the third boundary for generating a mirror image above the first flat surface, the first image sensing apparatus is disposed at a corner where the first boundary and the fourth boundary intersect with each other, a sensing range of the first image sensing apparatus covers the first flat surface and the plane mirror, the second image sensing module comprises a second image sensing apparatus, and the step of obtaining the image is employing the image sensing apparatus to obtain the image.
